(19) United States
(12) Patent Application Publication
(10) Pub. No.: US 2026/0058296 A1
(43) Pub. Date: Feb. 26, 2026

(54) BATTERY MODULE AND BATTERY PACK

(71) Applicant: SK ON CO., LTD., Seoul (KR)

(72) Inventors: Chul Jin BAE, Daejeon (KR); Chae Won NA, Daejeon (KR); Soo Geun PARK, Daejeon (KR); Gang U LEE, Daejeon (KR)

(21) Appl. No.: 19/303,377

(22) Filed: Aug. 19, 2025

(30) Foreign Application Priority Data
Aug. 22, 2024 (KR) 10-2024-0112959

(51) Int. Cl. H01M 50/342; H01M 10/658; H01M 50/211; H01M 50/271; H01M 50/375; H01M 50/383

(52) U.S. Cl. CPC H01M 50/3425; H01M 10/658; H01M 50/211; H01M 50/271; H01M 50/375; H01M 50/383; H01M 2200/10

(57) ABSTRACT

A battery module includes a cell array including a plurality of battery cells and a module housing accommodating the cell array, wherein the module housing includes a lower frame and an upper cover, the upper cover includes a venting portion, and the venting portion includes a weakened portion formed to be at least partially melted at or above a set temperature.

### CROSS-REFERENCE TO RELATED APPLICATION(S)

This patent document claims the priority and benefits of Korean Patent Application No. 10-2024-0112959 filed on Aug. 22, 2024, the disclosure of which is incorporated herein by reference in its entirety.

### TECHNICAL FIELD

The disclosure and implementations disclosed in this patent document generally relate to a battery module and a battery pack.

### BACKGROUND

A secondary battery is a type of energy storage device that may be charged with and discharged of electricity. Secondary batteries have been widely used in various units using electricity as a power source. For example, secondary batteries have been used as energy storage devices in various units ranging from small devices, such as mobile phones, laptops, and tablets to large devices, such as vehicles and aircraft. In particular, secondary batteries have been actively sought for use as a vehicle power source recently.

Secondary batteries may be classified as lead-acid batteries, nickel-cadmium batteries, nickel-hydrogen batteries, and lithium-ion batteries depending on the material of the electrode or the like. Each type of secondary battery may be appropriately selected depending on the design capacity, usage environment, or the like, thereof. Alternatively, secondary batteries may be all-solid-state batteries using a solid electrolyte instead of a liquid electrolyte. Lithium-ion batteries may implement relatively high voltage and capacity, as compared to other types of secondary batteries. Accordingly, lithium-ion batteries have been widely used in fields requiring high-density energy storage devices, such as vehicle battery packs.

Secondary batteries, such as lithium-ion batteries, may include a positive electrode, a negative electrode, a separator, and an electrolyte. The positive electrode and the negative electrode are arranged with an insulating separator in between, and charging or discharging may be performed by the migration of ions through the electrolyte.

Secondary batteries are manufactured as flexible pouch-type battery cells or rigid prismatic or cylindrical can-type battery cells.

A plurality of battery cells may be arranged inside a module housing to form a battery module, and a plurality of battery modules may be arranged inside a pack housing to form a battery pack.

In addition, recently, the formation of a battery module is omitted, and a cell-to-pack (CTP) method is used to directly integrate battery cells into a battery pack and connect the battery pack to a body frame.

Meanwhile, if thermal propagation occurs in the battery module, a re-entering phenomenon may occur in which gas, flames, or foreign matter discharged through a vent hole may collide with an external component and then re-enter the inside of the battery module or may re-enter the inside of the battery module by itself.

### SUMMARY

The present disclosure may be implemented in some embodiments to discharge gas, flames, or foreign matter to the outside of a battery module.

The present disclosure may be implemented in some embodiments to prevent a re-entering phenomenon.

The battery pack of the present disclosure may be widely applied to devices in green technology fields, such as electric vehicles, battery charging stations, and other solar power generation and wind power generation using batteries. In addition, the battery pack of the present disclosure may be used in eco-friendly electric vehicles, hybrid vehicles, etc. to prevent climate change by suppressing air pollution and greenhouse gas emissions.

In some embodiments of the present disclosure, a battery module includes a cell array including a plurality of battery cells and a module housing accommodating the cell array, wherein the module housing includes a lower frame and an upper cover, the upper cover includes a venting portion, and the venting portion includes a weakened portion formed to be at least partially melted at or above a set temperature.

The upper cover may include a base plate, and the venting portion may protrude upwardly from the base plate.

The venting portion may include a body portion, and the weakened portion may be formed to be thinner than the body portion.

The weakened portion may be disposed along a periphery of the body portion and may be connected to the base plate.

A thickness of the base plate may be 1.5 mm or more and 5 mm or less.

The venting portion may protrude upwardly from the base plate by 40% or more and 60% or less of a thickness of the base plate.

The cell array may include blocking members arranged in a first direction, which is an arrangement direction of the plurality of battery cells.

The blocking member may be disposed so as to not overlap the venting portion in a second direction, perpendicular to the first direction.

The upper cover may include a base plate, and the weakened portion may be formed to be thinner than the base plate.

The venting portion may be formed integrally with the base plate.

In some embodiments of the present disclosure, a battery module includes a cell array including a plurality of battery cells, a module housing accommodating the cell array and including a lower frame and an upper cover, and a heat-resistant member disposed between the upper cover and the cell array, wherein the upper cover includes a venting portion, the venting portion includes a weakened portion formed to be at least partially melted at a set temperature, and the heat-resistant member includes a melting guide portion formed at a position corresponding to the weakened portion.

The heat-resistant member may include a heat-resistant material to block high-temperature heat at the set temperature.

The melting guide portion may include a hole formed in a position corresponding to the weakened portion.

In some embodiments of the present disclosure, a battery pack includes a plurality of battery modules and a pack housing accommodating the plurality of battery modules, wherein each of the plurality of battery modules includes a cell array including a plurality of battery cells and a module housing accommodating the cell array, wherein the module housing includes a lower frame and an upper cover, the upper cover includes a venting portion, and the venting portion includes a weakened portion formed to be at least partially melted at a set temperature.

### BRIEF DESCRIPTION OF DRAWINGS

Certain aspects, features, and advantages of the present disclosure are illustrated by the following detailed description with reference to the accompanying drawings.

FIG. 1 is an exploded perspective view illustrating a battery module of a first embodiment;

FIG. 2 is a cross-sectional view illustrating a portion of an upper cover taken along line I-I′ of FIG. 1;

FIG. 3 is a schematic view illustrating a battery module in a state in which a thermal runaway situation occurs;

FIG. 4 is a schematic view illustrating a state in which gas, flames, or foreign matter are discharged;

FIG. 5 is a perspective view illustrating a battery module of a second embodiment;

FIG. 6 is a cross-sectional view illustrating a portion of an upper cover taken along line II-II′ of FIG. 5;

FIG. 7 is an exploded perspective view illustrating a battery module of a third embodiment;

FIG. 8 is a cross-sectional view illustrating a portion of an upper cover taken along line III-III′ of FIG. 7;

FIG. 9 is an exploded perspective view illustrating a battery module according to the present disclosure; and

FIG. 10 is a schematic view illustrating a battery pack in a state in which a thermal runaway situation occurs.

### DETAILED DESCRIPTION

Hereinafter, embodiments of the present disclosure will be described with reference to the accompanying drawings. For convenience, in the following description, detailed descriptions of well-known components or components that may obscure the technical gist of the present disclosure will be omitted.

Hereinafter, a battery module and a battery pack according to the present disclosure will be described in detail with reference to the drawings.

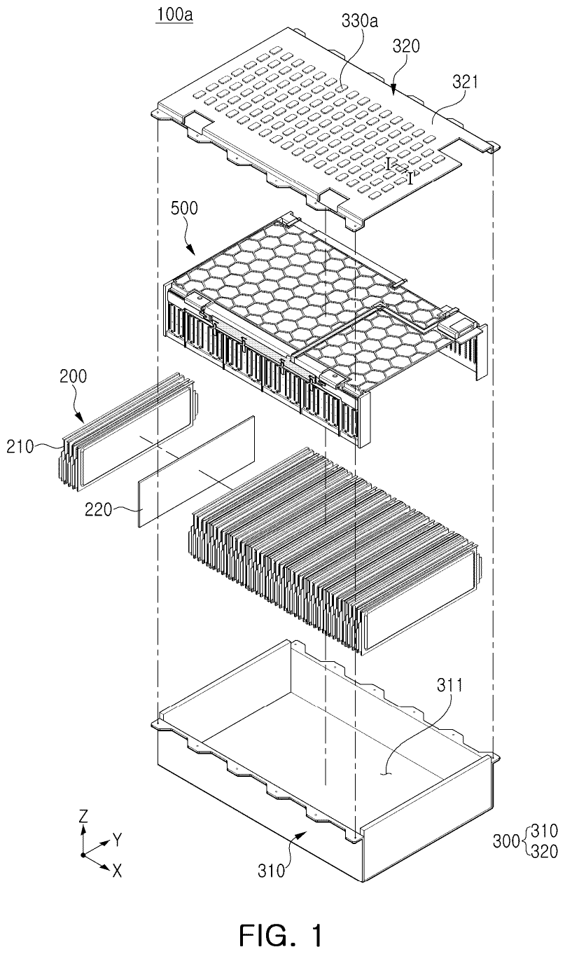

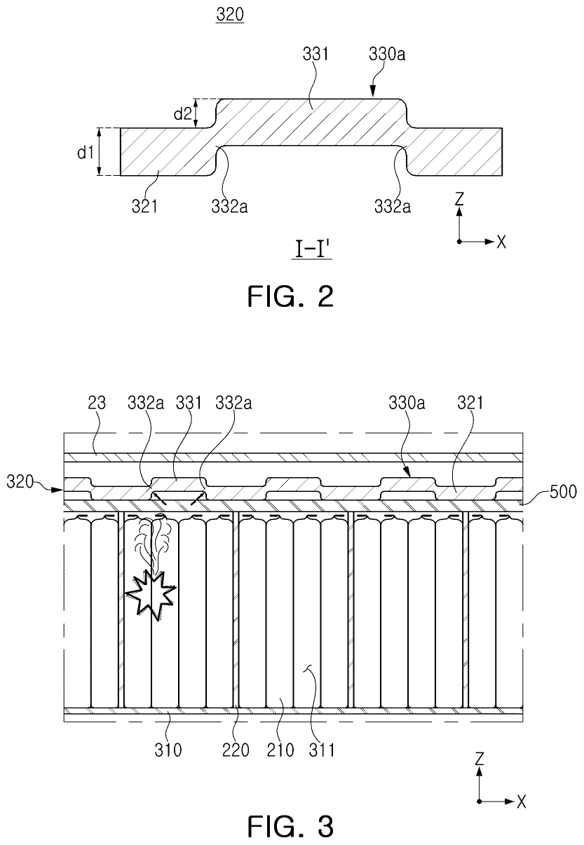

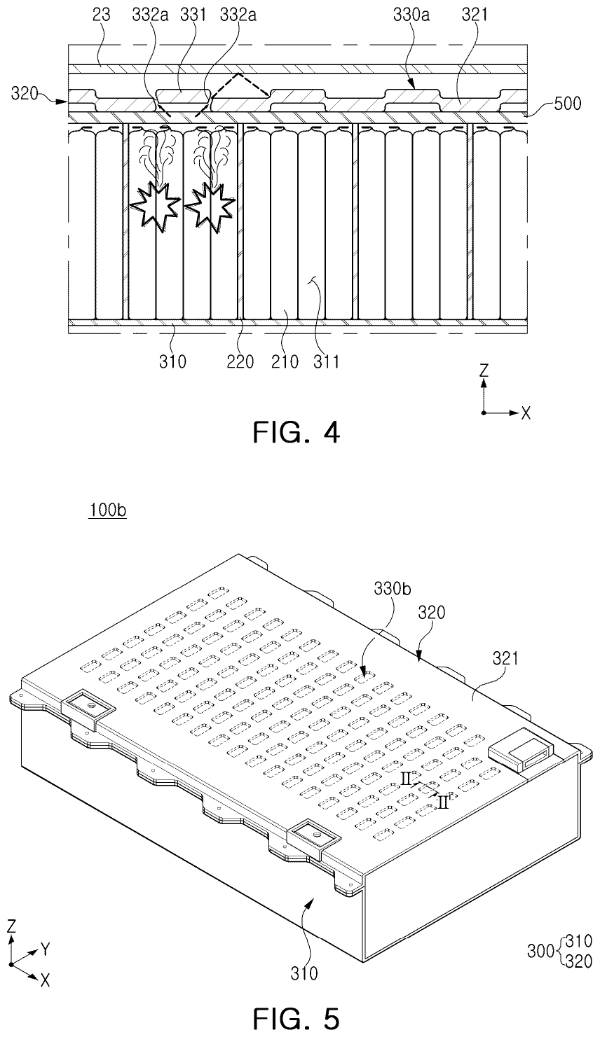

FIG. 1 is an exploded perspective view illustrating a battery module 100a of a first embodiment, FIG. 2 is a cross-sectional view illustrating a portion of an upper cover 320 taken along line I-I′ of FIG. 1, FIG. 3 is a schematic diagram illustrating the battery module 100a in a state in which a thermal runaway situation occurs, and FIG. 4 is a schematic diagram illustrating a state in which gas, flames, or foreign matter are discharged.

Referring to FIGS. 1 to 4, the battery module 100a may include a cell array 200 and a module housing 300.

The cell array 200 may include a plurality of battery cells 210. The plurality of battery cells 210 may be arranged and stacked in a certain direction X. Here, the arrangement direction of the battery cells 210 may be defined as a first direction X. Each battery cell 210 may output or store electrical energy.

The battery cell 210 may be formed of a lithium secondary battery, but is not limited thereto. For example, the battery cell 210 may be formed of various types of secondary batteries, such as a nickel-cadmium battery, a nickel-metal hydride battery, and a nickel-hydrogen battery. The battery cell 210 may be formed of a pouch-type secondary battery. Hereinafter, a case in which a pouch-type secondary battery is used as the battery cell 210 will be described as an example. However, the present disclosure does not exclude the use of a can-type secondary battery, such as a prismatic secondary battery or a cylindrical secondary battery, as the battery cell 210.

The cell array 200 may include a blocking member 220.

The blocking member 220 may be arranged in the first direction X and may be disposed parallel to the battery cell 210. The blocking member 220 may include a heat-resistant or fire-resistant material. For example, the blocking member 220 may include a metallic material, such as steel, aluminum, or nickel. Therefore, even if high-temperature gas or flames occurs, the high-temperature gas or flames may not pass through the blocking member 220.

The blocking member 220 may be arranged not to overlap a venting portion 330a in a second direction Z. The second direction Z mentioned here may be a direction, perpendicular to the first direction X. Alternatively, the second direction Z may be a vertical direction. Therefore, even if one of the venting portions 330a is open, gas or flames, etc., may not pass over the blocking member 220 via the same venting portion 330a.

The module housing 300 may accommodate the cell array 200. For example, the module housing 300 may include an accommodation space 311 accommodating the cell array 200. The accommodation space 311 may have a volume sufficiently large to accommodate the cell array 200.

The module housing 300 may include a lower frame 310 and an upper cover 320.

The lower frame 310 may cover a lower portion and a side surface of the battery module 100a. The accommodation space 311 may be located on the inner side of the lower frame 310. In other words, the lower frame 310 may cover a lower portion and a side surface of the cell array 200.

The upper cover 320 may cover the lower frame 310. The upper cover 320 may cover an upper portion of the battery module 100a and may be coupled to the lower frame 310. In other words, the upper cover 320 may cover the accommodation space 311 or the upper portion of the cell array 200.

The battery module 100a may further include a flexible printed circuit board (FPCB) frame 500 or the like. The FPCB frame 500 may be disposed between the upper cover 320 and the lower frame 310. However, the configuration of the FPCB frame 500 or the like is not essential and may be omitted as needed.

The upper cover 320 may include a base plate 321 and the venting portion 330a.

The base plate 321 may be a portion of the upper cover 320 excluding the venting portion 330a. That is, the venting portion 330a may be located in the middle of the base plate 321, and the base plate 321 may become a base of the upper cover 320.

The base plate 321 may include a metallic material. For example, the metallic material may include a metal, such as aluminum, iron, stainless steel, or an alloy thereof. Therefore, the base plate 321 may be processed by a process, such as a press mold.

A thickness d1 of the base plate 321 may be configured to be 1.5 mm or more or 5 mm or less. However, this thickness d1 is only an example. Therefore, the base plate 321 may be formed to be thinner than 1.5 mm or thicker than 5 mm as needed, and therefore, thicknesses in other numerical ranges are not excluded.

The venting portion 330a may be located on the base plate 321 as a component of the upper cover 320. The venting portion 330a may be configured to discharge gas, flames, or foreign matter occurring inside the battery module 100a.

The venting portion 330a may include a weakened portion 332a. The weakened portion 332a may be formed so that at least a portion thereof is melted at a set temperature or higher. The set temperature mentioned here may be a temperature for discharging gas, flames, or foreign matter occurring inside the battery module 100a externally. Referring to FIGS. 3 and 4, when a thermal runaway situation occurs in the battery module 100a, the temperature inside the battery module 100a may rise. Here, if the high temperature situation is maintained, problems, such as flames spreading to adjacent battery cells 210, may occur. Here, it is necessary to discharge the generated gas, flames, or foreign matter to the outside of the battery module 100a, and the temperature as a trigger for such discharge may be the set temperature. When the set temperature is reached, at least a portion of the weakened portion 332a may be melted. A gap may be formed in the melted weakened portion 332a, and the gas, flames, or foreign matter inside may be discharged to the outside of the battery module 100a through the gap.

The weakened portion 332a may be configured to be thin so as to be melted at the set temperature. For example, the venting portion 330a may include a body portion 331, and the weakened portion 332a may be formed to be thinner than the body portion 331.

Specifically, the body portion 331 may be a body of the venting portion 330a. The venting portion 330a may protrude upwardly from the base plate 321. This may be formed through a half-piercing method. The half-piercing method may refer to a method of pressing a portion of a metal plate and causing displacement of the corresponding portion but not piercing the metal plate. In other words, the venting portion 330a may be configured to protrude upwardly by half-piercing a portion of the base plate 321. Here, the body portion 331 may be a portion protruding upwardly from the base plate 321, and the weakened portion 332a may be a portion deformed by half-piercing. The venting portion 330a and the base plate 321 may be formed integrally.

The weakened portion 332a may be formed to be thinner than the body portion 331. Referring to FIG. 2, the weakened portion 332a may be formed to be thinner than the body portion 331 or the base plate 321. The weakened portion 332a may be arranged along the periphery of the body portion 331 and may be connected to the base plate 321. That is, the weakened portion 332a may be a portion connecting the body portion 331 to the base plate 321. The weakened portion 332a may be formed to be thin and may be more vulnerable to heat than other portions of the venting portion 330a. That is, when the set temperature is reached, the weakened portion 332a of the venting portion 330a may be melted first.

Conversely, when the set temperature is not reached, the weakened portion 332a may maintain a solid state without melting. The arrows illustrated in an upper portion of the battery cell 210 in FIG. 4 indicate the path of gas, flames, or foreign matter. Referring to FIG. 4, gas, flames, or foreign matter discharged through one venting portion 330a may move toward the adjacent venting portion 330a or may collide with an external component, such as a pack cover 23 or the like and then move toward the adjacent venting portion 330a. Even if the gas, flames, or foreign matter returns to the adjacent venting portion 330a, the weakened portion 332a of the corresponding venting portion 330a may be maintained in a solid state without melting, thereby preventing the gas, flames, or foreign matter from penetrating into the inside of the battery module 100a.

The venting portion 330a may protrude upwardly from the base plate 321 by 40% or more and 60% or less of the thickness d1 of the base plate 321. In other words, a displacement d2 by which the venting portion 330a protrudes upwardly may be 40% or more and 60% or less of the thickness d1 of the base plate 321. When the thickness d1 of the base plate 321 is 1.5 mm or more and 5 mm or less, it may allow the weakened portion 332a to be maintained and to not be broken by external impact or vibration.

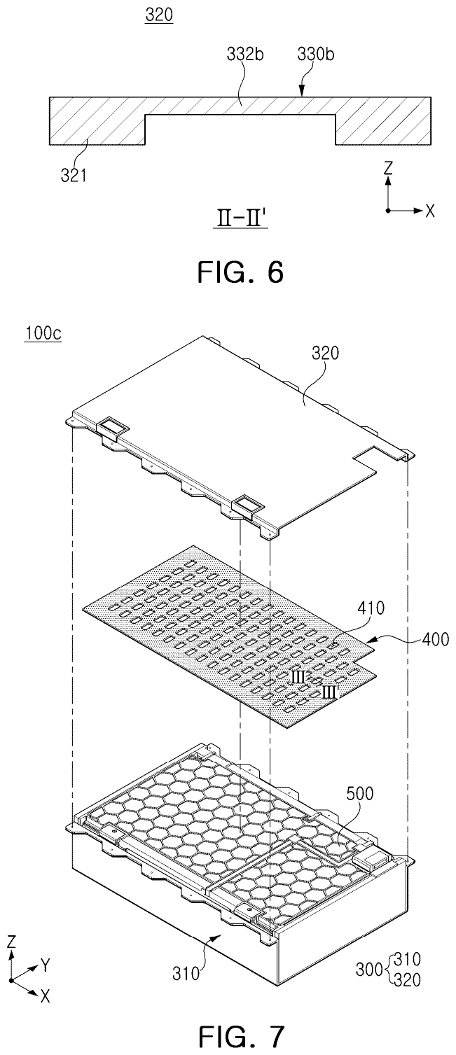

FIG. 5 is a perspective view illustrating a battery module 100b of a second embodiment, and FIG. 6 is a cross-sectional view illustrating a portion of the upper cover 320 taken along line II-II′ of FIG. 5.

Referring to FIGS. 5 and 6, the battery module 100b of the second embodiment differs from the battery module 100a of the first embodiment in the venting portion 330, and the other components of the battery module 100b may be the same as or similar to the components of the battery module 100a of the first embodiment.

A venting portion 330b may include a weakened portion 332b. The weakened portion 332b of the venting portion 330b may be formed to be thinner than the base plate 321.

For example, the upper cover 320 may include the base plate 321, and the base plate 321 may be the same as that of the first embodiment.

Here, the weakened portion 332b may be formed by thinly processing at least a portion of the base plate 321. That is, the weakened portion 332b may be formed by cutting off at least a portion of the base plate 321 through numerical control (NC) processing. Accordingly, the weakened portion 332b of the venting portion 330b and the base plate 321 may be formed integrally.

The weakened portion 332b may be processed sufficiently thinly to be melted at a set temperature. Accordingly, when the set temperature is not reached, the weakened portion 332b may not be melted and the venting portion 330b may be maintained from being opened. In other words, the intrusion of external gas, flames, or foreign matter may be prevented.

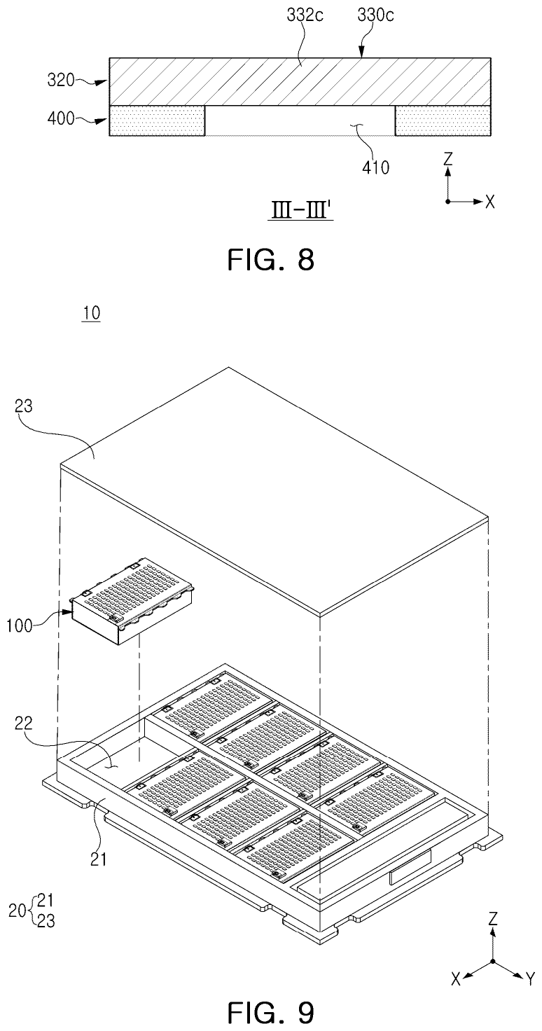

FIG. 7 is an exploded perspective view illustrating a battery module 100c of a third embodiment, and FIG. 8 is a cross-sectional view illustrating a portion of the upper cover 320 taken along line III-III′ of FIG. 7.

Referring to FIGS. 7 and 8, the battery module 100c of the third embodiment may additionally include a heat-resistant member 400 and may differ from the battery module 100a of the first embodiment or the battery module 100b of the second embodiment in the presence or absence of the heat-resistant member 400. Accordingly, the other components of the battery module 100c may be the same as or similar to those of the battery module 100a of the first embodiment or the battery module 100b of the second embodiment.

The heat-resistant member 400 may be disposed between the upper cover 320 and the cell array 200. That is, a heat-resistant member 400 may cover the upper portion of the lower frame 310 in which the cell array 200 is accommodated, and an upper cover 320 may cover the heat-resistant member 400.

The heat-resistant member 400 may include a heat-resistant material to block high-temperature heat at a set temperature. For example, mica may be applied as the heat-resistant material. Therefore, even if the set temperature is reached, high-temperature heat may not be easily transferred to the upper cover 320.

Here, the heat-resistant member 400 may include a melting guide portion 410. The melting guide portion 410 may be formed at a position corresponding to a weakened portion 332c. The melting guide portion 410 may include a hole formed in a position corresponding to the weakened portion 332c. When a thermal runaway situation occurs within the battery module 100c, high-temperature heat cannot pass through the blocking member 220 but may be transferred to the upper cover 320 through the melting guide portion 410 of the blocking member 220. Since the melting guide portion 410 is located at a position corresponding to the weakened portion 332c of the venting portion 330c, high-temperature heat may be transferred to the weakened portion 332c. Accordingly, the weakened portion 332c may be melted by the high-temperature heat, and at least a portion of the venting portion 330c may be opened.

Here, the venting portion 330c may not undergo separate processing as a portion of the base plate 321 or may be either the venting portion 330a of the first embodiment or the venting portion 330b of the second embodiment.

The battery module 100c may further include the FPCB frame 500 or the like. The FPCB frame 500 may be disposed between the heat-resistant member 400 and the lower frame 310. However, the configuration of the FPCB frame 500 or the like is not essential and may be omitted as needed.

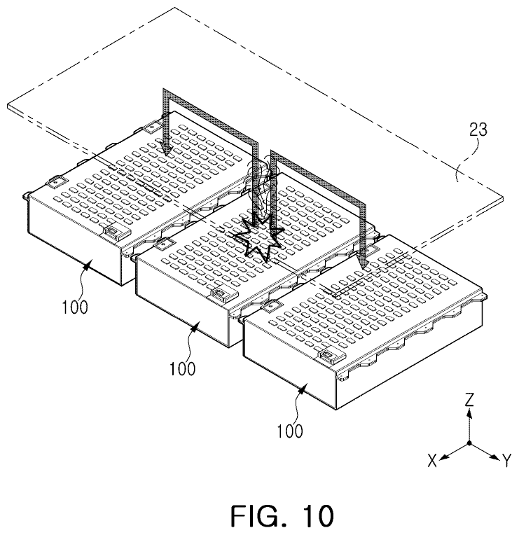

FIG. 9 is an exploded perspective view illustrating a battery module 100 according to the present disclosure, and FIG. 10 is a schematic diagram illustrating a battery pack 10 in a state in which a thermal runaway situation occurs.

Referring to FIGS. 9 and 10, the battery pack 10 may include a plurality of battery modules 100 and a pack housing 20.

The plurality of battery modules 100 may be an assembly in which the plurality of battery modules 100 are assembled.

Each battery module 100 may be one of the battery modules 100a, 100b, or 100c described above with reference to FIGS. 1 to 8.

The pack housing 20 accommodates the plurality of battery modules 100 and may include a pack frame 21 and a pack cover 23.

The pack frame 21 is located at the bottom of the battery pack 10 and may include a plurality of module accommodation spaces 22 to accommodate the plurality of battery modules 100. Each module accommodation space 22 may be partitioned by a partition.

The pack cover 23 may cover an upper portion of the pack frame 21. Therefore, the pack cover 23 may cover the upper portions of the plurality of battery modules 100 accommodated in the pack frame 21.

The arrows illustrated above the battery module 100 of FIG. 10 indicate a movement path of gas, flames, or foreign matter discharged from one battery module 100. Referring to FIG. 10, in a thermal runaway situation, the pack cover 23 may be configured to reflect gas, flames, or foreign matter. For example, gas, flames, or foreign matter discharged from one battery module 100 may rise upwardly, collide with the pack cover 23 located above the battery module 100, and then move to another battery module 100. Here, since the venting portion 330 of the adjacent other battery module 100 is not in an open state, the intrusion of external gas, flames, or foreign matter may be prevented.

According to an embodiment of the present disclosure, gas, flames, or foreign matter may be discharged to the outside of the battery module.

According to an embodiment of the present disclosure, the re-entering phenomenon may be prevented.

Only specific examples of implementations of certain embodiments are described. Variations, improvements and enhancements of the disclosed embodiments and other embodiments may be made based on the disclosure of this patent document.

What is claimed is:

1. A battery module comprising:
a cell array including a plurality of battery cells; and
a module housing accommodating the cell array,
wherein the module housing includes a lower frame and an upper cover,
the upper cover includes a venting portion,
and the venting portion includes a weakened portion formed to be at least partially melted at or above a set temperature.

2. The battery module of claim 1, wherein the upper cover includes a base plate, and
the venting portion protrudes upwardly from the base plate.

3. The battery module of claim 2, wherein the venting portion includes a body portion, and
the weakened portion is formed to be thinner than the body portion.

4. The battery module of claim 3, wherein the weakened portion is disposed along a periphery of the body portion and is connected to the base plate.

5. The battery module of claim 4, wherein a thickness of the base plate is 1.5 mm or more and 5 mm or less.

6. The battery module of claim 5, wherein the venting portion protrudes upwardly from the base plate by 40% or more and 60% or less of a thickness of the base plate.

7. The battery module of claim 1, wherein the cell array includes blocking members arranged in a first direction, which is an arrangement direction of the plurality of battery cells.

8. The battery module of claim 7, wherein the blocking member is disposed to not overlap the venting portion in a second direction, perpendicular to the first direction.

9. The battery module of claim 1, wherein the upper cover includes a base plate, and
the weakened portion is formed to be thinner than the base plate.

10. The battery module of claim 9, wherein the venting portion is formed integrally with the base plate.

11. A battery module comprising:
a cell array including a plurality of battery cells;
a module housing accommodating the cell array and including a lower frame and an upper cover; and
a heat-resistant member disposed between the upper cover and the cell array,
wherein the upper cover includes a venting portion,
the venting portion includes a weakened portion formed to be at least partially melted at a set temperature, and
the heat-resistant member includes a melting guide portion formed at a position corresponding to the weakened portion.

12. The battery module of claim 11, wherein the heat-resistant member includes a heat-resistant material to block high-temperature heat at the set temperature.

13. The battery module of claim 11, wherein the melting guide portion includes a hole formed in a position corresponding to the weakened portion.

14. A battery pack comprising:
a plurality of battery modules; and
a pack housing accommodating the plurality of battery modules,
wherein each of the plurality of battery modules includes:
a cell array including a plurality of battery cells; and
a module housing accommodating the cell array,
wherein the module housing includes a lower frame and an upper cover,
the upper cover includes a venting portion, and
the venting portion includes a weakened portion formed to be at least partially melted at a set temperature.
